(19) United States
(12) Patent Application Publication
(10) Pub. No.: US 2007/0257667 A1
(43) Pub. Date: Nov. 8, 2007

(54) Position sensors and arrays utilizing back EMF

(76) Inventors: Thaddeus Schroeder, Rochester Hills, MI (US); Avoki Omekanda, Rochester, MI (US)

Correspondence Address: DELPHI TECHNOLOGIES, INC., M/C 480-410-202, PO BOX 5052, TROY, MI, 48007, US

(21) Appl. No.: 11/416,681

(22) Filed: May 3, 2006

(51) Int. Cl. G01B 7/30

(52) U.S. Cl. 324/207.17

(57) ABSTRACT

A non-contact position sensor comprises a first reactive element for accepting radio frequency (RF) energy from an oscillator and radiating said RF energy to generate an excitation flux. A second reactive element intercepts the excitation flux and an RF voltage is induced therein. An RF voltage detector, operatively coupled to the second reactive element, detects the RF voltage induced in the second reactive element to generate an output voltage. A third reactive element is capable of intercepting the excitation flux to generate a back electromagnetic force (EMF) in the second reactive element such that, upon the third reactive element being displaced relative to at least one of the first and second reactive elements, the RF voltage detector generates a position-dependent output signal indicative of the displacement of the third reactive element.

### BACKGROUND

The present invention relates generally to sensing devices and, more particularly, to inductively coupled, non-contacting position sensors.

A variety of automotive and industrial control systems require non-contacting linear or angular position sensors capable of operating down to zero speed. For many system applications, a certain amount of physical ruggedness is required, thus precluding the use of optical or capacitive sensors. The most frequently utilized sensor satisfying the foregoing requirements is a magnetic sensor comprising an analog Hall or anisotropic magnetoresistor (MR) device. Hall devices utilize a current-carrying element, such as a semiconductor, that responds to an applied magnetic field by generating a voltage potential perpendicular to both the direction of current flow and the applied field. A magnetoresistor (MR) device is a two-terminal device that changes its resistance in accordance with changes in the applied magnetic field. These magnetic sensors operate in conjunction with a position responsive magnetic flux generating mechanism. The flux generation mechanism provides a magnetic flux which varies as a function of absolute position.

Hall and MR devices are disadvantageous in that they require a costly magnetic circuit capable of driving a bulky bias magnet. Moreover, the Hall or MR device must be equipped with integrated signal processing capabilities, further increasing the cost and complexity of the overall system. Accordingly, there still remains a need for providing a simple, inexpensive non-contact position sensor that is sufficiently rugged for use in a variety of automotive and industrial applications.

### SUMMARY

The aforementioned drawbacks and deficiencies of the prior art are addressed by providing a non-contact position sensor comprising a first reactive element for accepting radio frequency (RF) energy from an oscillator and radiating said RF energy to generate an excitation flux. A second reactive element intercepts the excitation flux and an RF voltage is induced therein. An RF voltage detector, operatively coupled to the second reactive element, detects the RF voltage induced in the second reactive element to generate an output voltage. A third reactive element is capable of intercepting the excitation flux to generate a back electromagnetic force (EMF) in the second reactive element such that, upon the third reactive element being displaced relative to at least one of the first and second reactive elements, the RF voltage detector generates a position-dependent output signal indicative of the displacement of the third reactive element.

Pursuant to another embodiment, a non-contacting differential position sensor comprises a first reactive element for accepting radio frequency (RF) energy from an oscillator and radiating said RF energy to generate an excitation flux. A second reactive element and a third reactive element are also utilized. Upon the second reactive element intercepting the excitation flux, a first RF voltage is induced therein. Upon the third reactive element intercepting the excitation flux, a second RF voltage is induced therein. An RF voltage detector, operatively coupled to the second and third reactive elements, detects at least one of the first and second RF voltages and, in response thereto, generates an output voltage. A fourth reactive element is capable of intercepting the excitation flux to generate a back electromagnetic force (back EMF) in at least one of the second reactive element or the third reactive element, such that, upon the fourth reactive element being displaced relative to at least one of the first, second, or third reactive elements, the RF voltage detector generates a position-dependent output signal indicative of the displacement of the fourth reactive element.

Pursuant to yet another embodiment, a non-contacting position sensor array comprises a first reactive element for accepting radio frequency (RF) energy from an oscillator and radiating said RF energy to generate an excitation flux. A reactive element array comprises a plurality of receiving elements wherein, upon at least one of the receiving elements intercepting the excitation flux, an RF voltage is induced in the reactive element array. An RF voltage detection mechanism, operatively coupled to the reactive element array, detects the RF voltage induced in the reactive element array to generate an output voltage. A second reactive element is capable of intercepting the excitation flux to generate a back electromagnetic force (back EMF) in the reactive element array such that, upon the second reactive element being displaced relative to at least one of the first reactive element and the reactive element array, the RF voltage detector generates a position-dependent output signal indicative of the displacement of the second reactive element.

### BRIEF DESCRIPTION OF THE DRAWINGS

Referring to the exemplary drawings wherein like elements are numbered alike in the several Figures:

FIG. 1 is a diagrammatic representation of a position sensor constructed in accordance with a first set of embodiments of the present invention;

FIG. 2 is graph depicting the relationship between relative amplitude and relative displacement for the position sensor of FIG. 1;

FIG. 3 is a diagrammatic representation of a differential position sensor constructed in accordance with a second set of embodiments of the present invention;

FIG. 4 is a diagrammatic representation of a differential position sensor constructed in accordance with a third set of embodiments of the present invention;

FIG. 5 is a graph depicting the relationship between relative output voltage and relative displacement for the differential position sensor of FIG. 3; and

FIG. 6 is a diagrammatic representation of a sensor array constructed in accordance with a third set of embodiments of the present invention.

### DETAILED DESCRIPTION

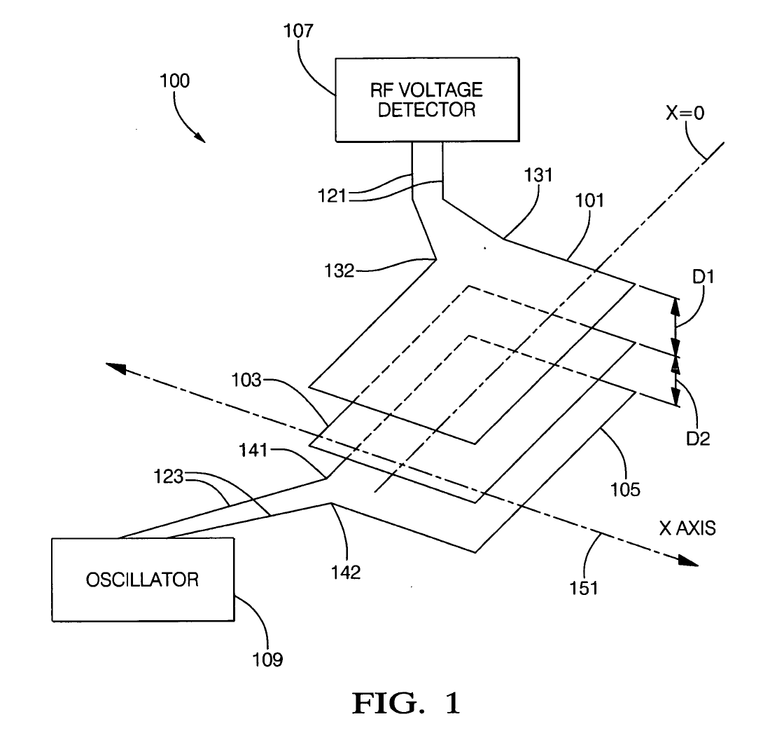

FIG. 1 is a diagrammatic representation of a position sensor 100 constructed in accordance with a first set of embodiments of the present invention. A receiver coil 101 is operatively coupled to an RF voltage detector 107, and an excitation coil 105 is operatively coupled to an oscillator 109. Oscillator 109 is capable of generating electromagnetic energy at one or more radio frequencies which, illustratively, may be in the range of approximately 0.4 to 30 MHz. When excitation coil 105 is fed with electromagnetic energy produced by oscillator 109, the excitation coil generates a magnetic excitation flux in a flux region surrounding the coil. According to one embodiment of the invention, oscillator 109 operates at a frequency in the range of 0.5 to 1.0 MHz. An unmodulated sinusoidal or square-wave oscillator could, but need not, be employed to implement oscillator 109. For some system applications, the power output of oscillator 109 may be selected so as not to exceed applicable Federal Communications Commission (FCC) limitations governing RF emissions, and also to avoid interference with other users of the RF spectrum, especially in situations where the frequency of oscillator 109 falls within the AM broadcast band.

The magnetic excitation flux generated by excitation coil 105 induces radio frequency (RF) currents to flow in receiver coil 101. The induced current in receiver coil 101 creates a voltage potential across receiver coil 101. RF voltage detector 107 detects the voltage potential across receiver coil 101, and uses this detected voltage potential to produce a detected waveform. Exemplary embodiments of RF voltage detector 107 include a peak detector, a rectifier, one or more semiconductor diodes, an envelope detector, or the like. Optionally, RF voltage detector 107 may include one or more amplifier or buffer stages, so as to provide sufficient voltage or current to interface with other electronic equipment, such as a microprocessor or a computing device. Pursuant to another optional feature, RF voltage detector 107 may include output filtering circuitry, such as a low-pass filter, to smooth a waveform envelope corresponding to the detected RF voltage as a function of time. Pursuant to yet another optional feature, RF voltage detector 107 may include input filtering circuitry, such as a bandpass filter tuned approximately to the frequency of oscillator 109, to enhance detection of RF energy emitted by oscillator 109 while reducing detection of ambient sources of RF interference.

Receiver coil 101, target coil 103, and excitation coil 105 each represent reactive elements capable of generating a magnetic excitation flux in response to RF energy being applied thereto. Pursuant to the principle of reciprocity, an alternating RF voltage will be induced in these reactive elements in the presence of an applied electromagnetic field. From a practical standpoint, receiver coil 101, target coil 103, and excitation coil 105 may each be implemented using reactive elements such as coils, conductive traces, wires, or inductors. Illustratively, receiver coil 101, target coil 103, and excitation coil 105 may each be fabricated using stationary planar air-core coils formed on one or more printed circuit boards. For example, receiver coil 101 may be implemented by forming one or more conductive traces on a printed circuit board, whereby the conductive traces together form a coil that includes at least one turn or loop having a first end 131 and a second end 132. Excitation coil 105 may be implemented in a manner substantially similar to that of receiver coil 101, so as to include at least one turn or loop having a first end 141 and a second end 142. Target coil 103 may be formed using one or more traces on a printed circuit board but, unlike receiver coil 101, the conductive traces together form a continuous coil of at least one turn or loop, such that the first and second ends of the coil are effectively joined together.

Receiver coil 101, target coil 103, and excitation coil 105 could, but need not, be fabricated such that two or more of these coils are of equal size and have substantially identical dimensions. For example, the aspect ratio of one or more of these coils can be selected to obtain a desired resolution or detection range for target coil 103. Instead of using a single excitation coil 105—receiver coil 101 pair, several excitation coil 105-receiver coil 101 pairs could be employed for increased target resolution accuracy, and/or to cover a broader target detection volume. The size of excitation coil 105 could be increased relative to that of receiver coil 101, so as to provide an excitation flux for more than one receiver coil 101, and/or so as to provide a relatively constant level of excitation flux across an expected range of target coil 103 movement. Pursuant to another variation, the size of receiver coil 101 could be increased relative to that of excitation coil 105, so as to provide reception of excitation flux from more than one excitation coil 105.

Receiver coil 101 includes a mechanism by which RF energy may be extracted from the coil, such that the coil may be utilized to sense an applied magnetic excitation flux. Excitation coil 105 includes a mechanism by which RF energy may be fed to the coil, such that the coil may be utilized to generate an excitation flux. In the exemplary embodiment of FIG. 1, an RF feedline 121 is connected to the first end 131 and second end 132 of receiver coil 101. Similarly, an RF feedline 123 is connected to the first end 141 and second end 142 of excitation coil 105. However, the foregoing RF feedline arrangement is described for illustrative purposes only, as any of a variety of techniques could be used to feed RF into excitation coil 105, and to extract RF from receiver coil. For example, at least one of receiver coil 101 and excitation coil 105 could be fabricated in a manner similar to that of target coil 103, using conductive traces which together form a continuous coil of at least one turn or loop, such that the first and second ends of the coil are effectively joined together. The resulting continuous loop could then be shunt-fed using feedline 121 or 123. As a further alternative, RF energy may be capacitively coupled from receiver coil 101 to RF power detector 107, and from oscillator 109 to excitation coil 105. Finally, any of various combinations of the foregoing RF feed mechanisms may be employed.

Position sensor 100 is capable of sensing the relative position of target coil 103 along X-axis 151 with reference to stationary receiver coil 101 and stationary excitation coil 105. Illustratively, receiver coil 101 and excitation coil 105 remain at a stationary position while the position of target coil 103 is changed. Position sensor 100 can sense the position of target coil 103 even if the velocity of the target coil is zero with respect to stationary receiver coil 101 and stationary excitation coil 105. Together, excitation coil 105, target coil 103 and receiver coil 101 function as a high frequency (0.5-30 MHz) variable transformer. The shorted turn(s) of target coil 103 create a back electromagnetic force (EMF) which counters the excitation flux generated by excitation coil 105 within an area where target coil 103 overlaps excitation coil 105 and receiver coil 101. This countering of excitation flux results in a proportional decrease in the amplitude of RF energy intercepted by receiver coil 101. As used herein, the term “back EMF” refers to any electromagnetic force that opposes a change of current in an inductive element, such as receiver coil 101.

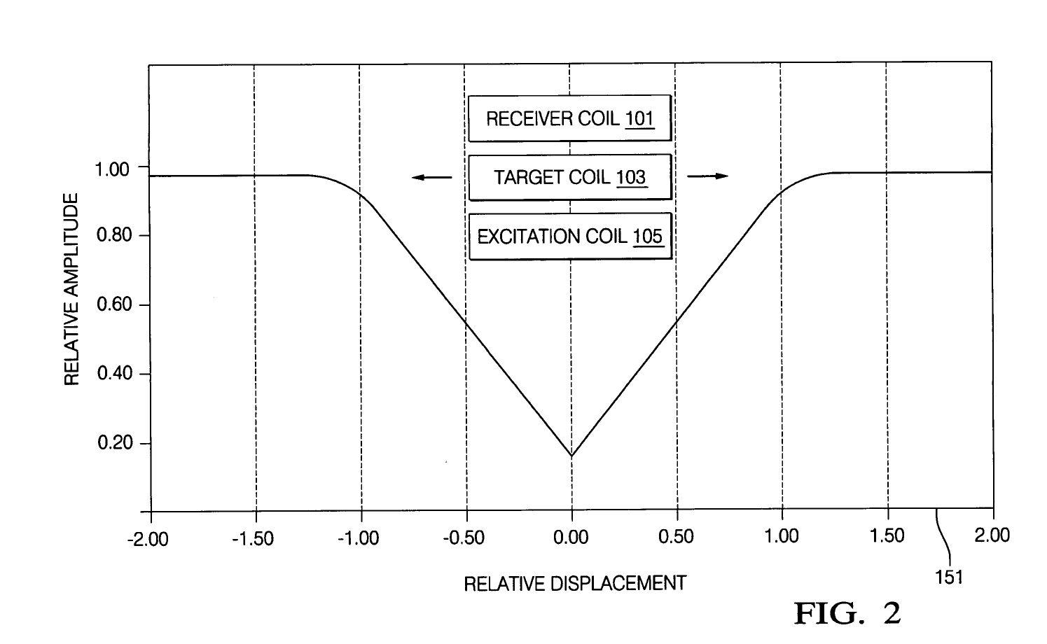

The dependence of the voltage (V₀) detected by RF voltage detector 107 as a function of target coil 103 displacement along X-axis 151 is graphically depicted in FIG. 2. The RF voltage generated by oscillator 109 (FIG. 1) is denoted mathematically as Vₑₓ=V₀ sin ωt, with the corresponding RF current being denoted as Iₑₓ=I₀ sin ωt. As used herein, V₀ is the amplitude of oscillator 109, I₀ is the current delivered by oscillator 109, ω is the angular frequency in radians of oscillator 109, and t refers to time. When applied to excitation coil 105, Vₑₓ generates an excitation flux that induces a current (and a voltage) in receiver coil 101. The voltage induced in receiver coil 101 for detection by RF voltage detector 107 is given by V_{out=f(x, I}ₑₓ)sin(ωt+φ).

Referring now to FIG. 2, assume that receiver coil 101 and excitation coil 105 are at a substantially fixed position, with movable target coil 103 free to move along X-axis 151. As relative displacement of target coil 103 from receiver coil 101 and excitation coil 105 approaches a minimum along X-axis 151, the voltage detected by RF voltage detector 107 (FIG. 1) is at a minimum. As displacement of target coil 103 from receiver coil 101 and excitation coil 105 increases along X-axis 151 (FIG. 2), the voltage detected by the RF voltage detector also increases. However, once a substantial relative displacement is achieved, in this example represented by a relative displacement of at least plus or minus two, no further increase in detected RF voltage is observed.

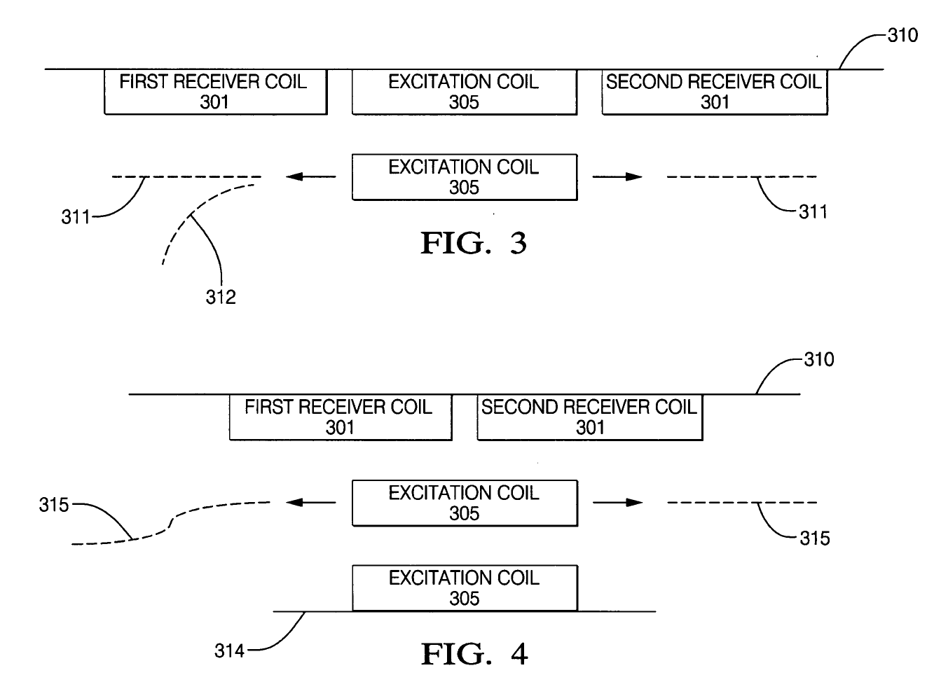

FIG. 3 is a diagrammatic representation of a differential position sensor constructed in accordance with a second set of embodiments of the present invention. The configuration of FIG. 3 is similar to that of FIG. 2, except that FIG. 3 employs an additional receiver coil in the form of a second receiver coil 302. Illustratively, first and second receiver coils 301 and 302 are positioned substantially at either side of excitation coil 305. It is possible, but not required, to position first receiver coil 301, second receiver coil 302, and excitation coil 305 in the same plane (i.e., reference plane 310). However, if these coils 301, 302, and 305 are all positioned in reference plane 310, this permits coils 301, 302 and 305 to be fabricated using a single printed circuit board.

In operation, target coil 303 is moved along a path, such as linear path 311 or nonlinear path 312. Linear path 311 and nonlinear path 312 are shown only for purposes of illustration, it being understood that target coil 303 could be moved along any path, so long as target coil 303 receives a magnetic excitation flux from excitation coil 305 at least throughout a portion of this path. For example, the path could, but need not, be substantially parallel to first reference plane 310.

FIG. 4 is a diagrammatic representation of a differential position sensor constructed in accordance with a third set of embodiments of the present invention. The configuration of FIG. 4 is similar to that of FIG. 3, except that first receiver coil 301 and second receiver coil are situated substantially along reference plane 310, whereas excitation coil 305 is situated in another plane denoted as excitation coil plane 314. Reference plane 310 and excitation coil plane 314 could, but need not, be parallel planes.

In operation, target coil 303 is moved along a path, such as path 315, which may be a linear path or a nonlinear path. Path 315 is shown only for purposes of illustration, it being understood that target coil 303 could be moved along any path, so long as the path includes at least one point wherein target coil 303 receives a magnetic excitation flux from excitation coil 305 and this flux is substantially simultaneously received by at least one of first receiver coil 301 and second receiver coil 302. In the present example, a portion of path 315 passes between excitation coil 305 and at least one of first receiver coil 301 and second receiver coil 302.

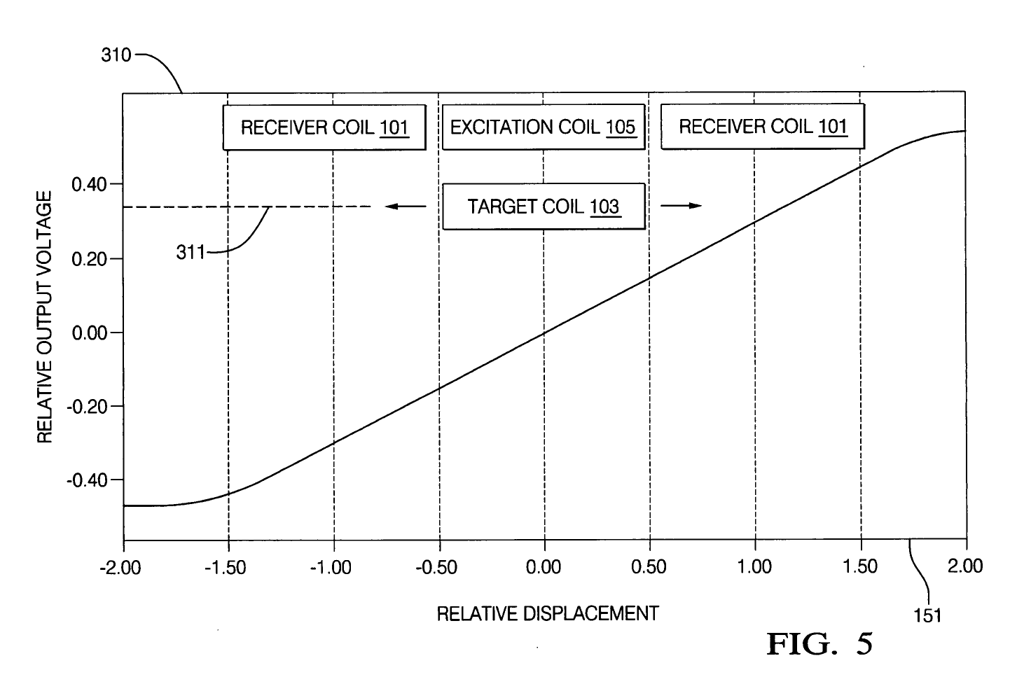

FIG. 5 is a graph depicting the relationship between relative output voltage and relative displacement for the differential position sensor of FIG. 3 when target coil 303 is moved along linear path 311 substantially parallel to first reference plane 310. When target coil 303 is moved to a position along linear path 311 closest to excitation coil 305, denoted by a relative displacement value of zero, the relative output voltage generated by RF voltage detector 107 (FIG. 1) is zero. As target coil 303 is moved to the left along linear path 311 (FIG. 5) from a relative displacement value of zero, the relative voltage generated by RF voltage detector 107 decreases. However, once the relative displacement of target coil 303 moves beyond −1.50 to −2.00, further displacements to the left (i.e., in a negative direction) do not result in substantial changes in relative output voltage.

As target coil 303 is moved to the right along linear path 311 from a relative displacement value of zero, the relative voltage generated by RF voltage detector 107 (FIG. 1) increases. However, once the relative displacement of target coil 303 moves beyond +1.50 to +2.00, further displacements to the right (i.e., in a positive direction) do not result in substantial changes in output voltage. It is to be understood that the values presented in FIG. 5 are for purposes of illustration only, as the actual voltage values obtained will depend upon the implementational details of specific system applications.

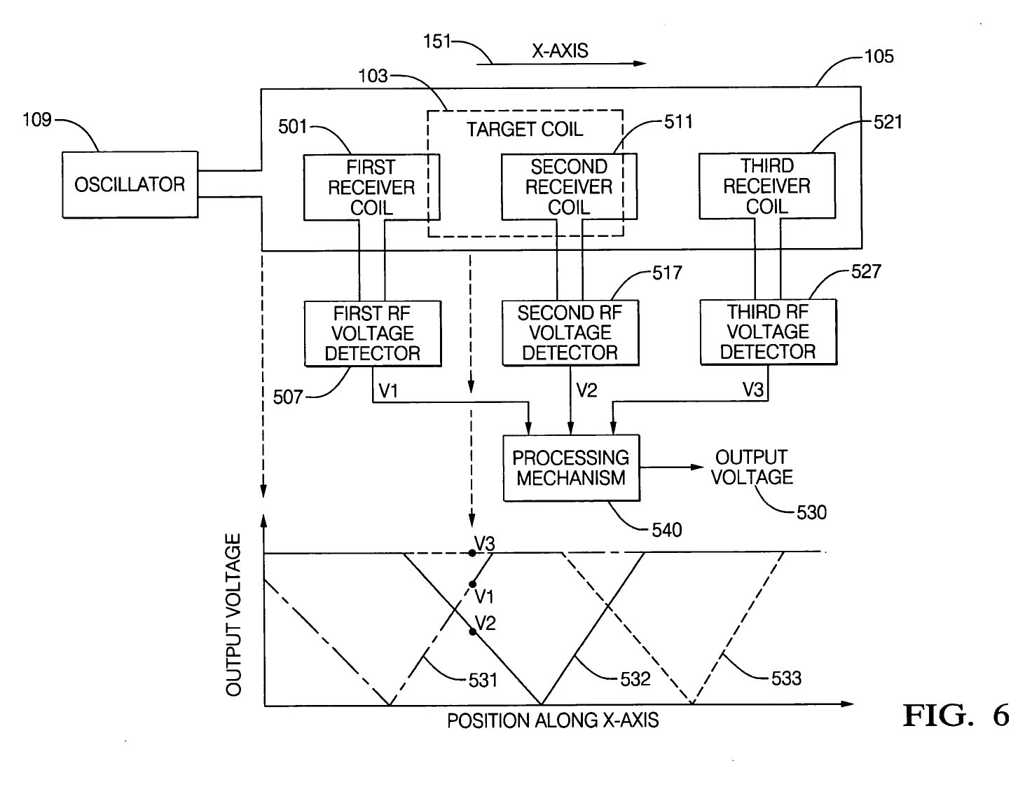

FIG. 6 is a diagrammatic representation of a sensor array constructed in accordance with a third set of embodiments of the present invention. Similar to the configuration of FIG. 1, oscillator 109 of FIG. 6 feeds RF energy into excitation coil 105, so as to generate a magnetic excitation flux. However, excitation coil 105 of FIG. 6 is dimensioned so as provide a magnetic excitation flux for receipt at a plurality of receiver coils including first receiver coil 501, second receiver coil 511, and third receiver coil 521. First receiver coil 501 is operatively coupled to a first RF voltage detector 507, second receiver coil 511 is operatively coupled to a second RF voltage detector 517, and third receiver coil 521 is operatively coupled to a third RF voltage detector 527.

First RF voltage detector 507 is capable of detecting a magnetic flux intercepted by first receiver coil 501. The magnetic flux is detected in the form of a voltage denoted as V1. Similarly, second RF voltage detector 517 is capable of detecting a magnetic flux intercepted by second receiver coil 511, wherein the magnetic flux is detected in the form of a voltage denoted as V2. Finally, third RF voltage detector 527 is capable of detecting a magnetic flux intercepted by third receiver coil 521, wherein the magnetic flux is detected in the form of a voltage denoted as V3.

Illustratively, RF voltage detectors 507, 517 and 527 may each be implemented using a peak detector, a rectifier, one or more semiconductor diodes, an envelope detector, or the like. However, a single device such as a single peak detector, rectifier, or diode could optionally be employed to implement a plurality of RF voltage detectors 507, 517, 527, wherein a switching mechanism would be employed to sequentially direct voltage detected from first, second, and third receiver coils 501, 511, 521 to the single device. Optionally, RF voltage detectors 507, 517, and 527 may include one or more amplifier or buffer stages, so as to provide sufficient voltage or current to interface with other electronic equipment, such as a microprocessor or a computing device. Pursuant to another optional feature, RF voltage detectors 507, 517, and 527 may include output filtering circuitry, such as low-pass filters, to smooth a waveform envelope corresponding to the detected RF voltage as a function of time. Pursuant to yet another optional feature, RF voltage detectors 507, 517, 527 may include input filtering circuitry, such as a bandpass filter tuned approximately to the frequency of oscillator 109, to enhance detection of excitation flux generated by oscillator 109 while reducing detection of ambient sources of interference.

Detected voltages V1, V2, and V3 are fed to respective data input ports of a processing mechanism 540. Processing mechanism 540 may be implemented, for example, using a microprocessor, microcontroller, logic gates, discrete circuitry, computing device, or the like. Illustratively, processing mechanism 540 is programmed to apply a mathematical algorithm to detected voltages V1, V2, and V3, so as to generate an output voltage 530.

Illustratively, first, second, and third receiver coils 501, 511, and 521 are arranged to form an array. Such an array could be linear (as shown in FIG. 6), curvilinear, angular, or two-dimensional, so as to meet the requirements of specific system applications. Optionally, processing mechanism 540 may be programmed to implement pattern-based or value-based target sensing.

FIG. 6 displays a graph of output voltage 530 versus position of target coil 103 along X-axis 151. A first waveform 531 corresponds to detected voltage V1 detected by first RF voltage detector 507 as a function of the position of target coil 103. Similarly, a second waveform 532 corresponds to detected voltage V2 detected by second RF voltage detector 517 as a function of the position of target coil 103. Finally, a third waveform 533 corresponds to detected voltage V3 as a function of the position of target coil 103.

As will be also appreciated, the above described method embodiments may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A non-contacting position sensor comprising:
a first reactive element for accepting radio frequency (RF) energy from an oscillator and radiating said RF energy to generate an excitation flux;
a second reactive element wherein, upon intercepting the excitation flux, an RF voltage is induced therein;
an RF voltage detector, operatively coupled to the second reactive element, for detecting the RF voltage induced in the second reactive element to generate an output voltage;
a third reactive element capable of intercepting the excitation flux to generate a back electromagnetic force (EMF) in the second reactive element, such that, upon the third reactive element being displaced relative to at least one of the first and second reactive elements, the RF voltage detector generates a position-dependent output signal indicative of the displacement of the third reactive element.

2. The non-contacting position sensor of claim 1 wherein the first reactive element and the second reactive element each comprise an electrically conductive loop having one or more turns.

3. The non-contacting position sensor of claim 2 wherein the third reactive element comprises an electrically conductive loop having one or more turns.

4. The non-contacting position sensor of claim 3 wherein the first, second, and third electrically conductive loops have substantially identical dimensions.

5. The non-contacting position sensor of claim 4 wherein the first, second, and third electrically conductive loops are fabricated using one or more conductive traces on one or more printed circuit boards.

6. The non-contacting position sensor of claim 1 wherein the oscillator operates substantially at one or more frequencies in a frequency range of 0.5 to 30 MHz.

7. The non-contacting position sensor of claim 1 wherein the RF voltage detector is capable of generating a position-dependent output signal indicative of the displacement of the third reactive element when the third reactive element has zero velocity relative to the first and second reactive elements.

8. A non-contacting differential position sensor comprising:
a first reactive element for accepting radio frequency (RF) energy from an oscillator and radiating said RF energy to generate an excitation flux;
a second reactive element;
a third reactive element;
upon the second reactive element intercepting the excitation flux, a first RF voltage being induced therein;
upon the third reactive element intercepting the excitation flux, a second RF voltage being induced therein;
an RF voltage detector, operatively coupled to the second and third reactive elements, for detecting at least one of the first and second RF voltages and, in response thereto, generating an output voltage; and
a fourth reactive element capable of intercepting the excitation flux to generate a back electromagnetic force (back EMF) in at least one of the second reactive element or the third reactive element, such that, upon the fourth reactive element being displaced relative to at least one of the first, second, or third reactive elements, the RF voltage detector generates a position-dependent output signal indicative of the displacement of the fourth reactive element.

9. The non-contacting differential position sensor of claim 8 wherein the second and third reactive elements are situated substantially in the same plane.

10. The non-contacting differential position sensor of claim 8 wherein the first, second, and third reactive elements are situated substantially in the same plane.

11. A non-contacting position sensor array comprising:
a first reactive element for accepting radio frequency (RF) energy from an oscillator and radiating said RF energy to generate an excitation flux;
a reactive element array comprising a plurality of receiving elements wherein, upon at least one of the receiving elements intercepting the excitation flux, an RF voltage is induced in the reactive element array;
an RF voltage detection mechanism, operatively coupled to the reactive element array, for detecting the RF voltage induced in the reactive element array to generate an output voltage;
a second reactive element capable of intercepting the excitation flux to generate a back electromagnetic force (back EMF) in the reactive element array such that, upon the second reactive element being displaced relative to at least one of the first reactive element and the reactive element array, the RF voltage detector generates a position-dependent output signal indicative of the displacement of the second reactive element.

12. The non-contacting position sensor array of claim 11 wherein the reactive element array comprises a plurality of reactive elements disposed substantially in the same plane.

13. The non-contacting position sensor array of claim 12 wherein the reactive element array further comprises a linear array.

14. The non-contacting position sensor array of claim 12 wherein the reactive element array further comprises a curvilinear array.

15. The non-contacting position sensor array of claim 12 wherein the reactive element array further comprises a two-dimensional array.

16. The non-contacting position sensor array of claim 12 wherein the plurality of reactive elements comprises a plurality of single-turn loops.

17. The non-contacting position sensor array of claim 11 wherein the RF voltage detection mechanism comprises a plurality of respective RF voltage detectors each coupled to a corresponding reactive element of the plurality of reactive elements.

18. The non-contacting position sensor array of claim 17 wherein the plurality of respective RF voltage detectors each generates a detected voltage from a corresponding reactive element of the plurality of reactive elements, and wherein the RF voltage detection mechanism further comprises a microprocessor, operatively coupled to the plurality of respective RF voltage detectors, for generating an output voltage as a function of detected voltage for the plurality of reactive elements.
